(19) United States
(12) Patent Application Publication
(10) Pub. No.: US 2009/0095063 A1
(43) Pub. Date: Apr. 16, 2009

(54) HYBRID VEHICLE TESTING SYSTEM AND METHOD

(76) Inventor: Akihiko Kanamori, Aichi (JP)

Correspondence Address: KENYON & KENYON LLP, 1500 K STREET N.W., SUITE 700, WASHINGTON, DC, 20005, US

(21) Appl. No.: 12/296,042

(22) PCT Filed: Oct. 5, 2007
(86) PCT No.: PCT/JP2007/070024

§ 371 Date: Oct. 3, 2008

(30) Foreign Application Priority Data
Nov. 3, 2006 (JP) 2006-299713

(51) Int. Cl. G01L 3/26; G01M 17/007

(52) U.S. Cl. 73/116.05; 903/905; 903/906

(57) ABSTRACT

In a hybrid vehicle, first, an engine is locked by an engine shaft locking mechanism. A first motor is operated by torque control and a second motor is operated by number-of-revolutions control. Torque for controlling the second motor in this state is obtained. Based on the obtained control torque, whether the first motor is normal is checked. Successively, the second motor is operated by the torque control and the first motor is operated by the number-of-revolutions control to check whether the second motor is normal in a similar manner.

### TECHNICAL FIELD

The present invention relates to a hybrid vehicle testing system and method for testing the performance of a hybrid vehicle. More particularly, the invention relates to a hybrid vehicle testing system and method capable of testing the performances of drive units including a drive source (motor) for a hybrid vehicle and, with respect to a vehicle having poor performance, specifying the cause of the poor performance.

### BACKGROUND ART

In recent years, from the viewpoint of lower pollution and the like, attention is paid to a hybrid vehicle using an engine and a motor as power sources and traveling while controlling the engine and the motor. In such a hybrid vehicle, a power transmission unit (transaxle) for outputting power obtained from the motor and the engine to a drive shaft via a transmission is mounted. This technique is disclosed in JP2001-164960A, for example.

A hybrid vehicle is requested to have high-precision torque performance for realizing smooth travel. Techniques for testing the hybrid vehicle are disclosed in, for example, JP2004-219354A and JP2005-140668A. Specifically, JP2004-219354A discloses a technique for testing the performance of a motor and capable of specifying the cause of a failure. JP2005-140668A discloses a technique for testing the performance of a transaxle including two motors and a differential device and capable of specifying the cause of a failure.

However, the aforementioned conventional hybrid vehicle testing techniques have the following problems. Specifically, the testing techniques disclosed in JP2004-219354A and JP2005-140668A relate to tests of a single motor or a single transaxle but not tests to be conducted in a state where the motor or transaxle is combined with another unit (for example, an engine, an inverter, or a battery). That is, although a test can be conducted for a single unit by using a dedicated tester, each of units cannot be tested as a vehicle state which is a final product form. Consequently, in the case where a failure is detected in a vehicle state (for example, a failure which occurs in a general test just before shipment or in use), the region of the failure, which is in the drive unit itself or in a part combined with another unit, cannot be specified, so that the whole hybrid system has to be replaced.

### DISCLOSURE OF THE INVENTION

### Problems to be Solved by the Invention

The present invention has been made to solve the above problems and has an object to provide a hybrid vehicle testing system and method capable of conducting a test that specifies a failure unit in a final product form in which a drive unit for a hybrid vehicle is combined with another unit.

### Means for Solving the Problems

The above objects are attained by combinations of the features set forth in independent claim(s), and dependent claims give further advantageous embodiments of the present invention.

Specifically, a first aspect of the present invention provides a hybrid vehicle testing system for performing a test of a hybrid vehicle in which a drive unit including a first motor and a second motor and an engine are mounted as power sources so that power transmission is allowed between the engine, the first motor, and the second motor, wherein the testing system is arranged to perform the test by: locking one of the engine, the first motor, and the second motor; operating the remaining two power sources to obtain output characteristics of the power sources; switching locking and operating states of the power sources and obtaining the output characteristics of the power sources to be tested in at least two combinations of the locking and operating states; and determining whether each power source is normal or not based on the output characteristics.

The hybrid vehicle testing system of the present invention is a system for testing each of power sources which are an engine, a first motor, and a second motor mounted on a hybrid vehicle. At the time of conducting a test, any one of the power sources is locked (a locking step). By locking the revolutions of one of the power sources, only two power sources are made operable. The torque of one of the operable power sources is transmitted to the other power source with reliability. In a state where the operable power sources are caused to operate, the output characteristic of the power source which is operating is obtained (an output characteristic obtaining step). For example, one of the power sources is operated by the torque control, the other power source is operated by the number-of-revolutions control, and the output characteristics (output torque, the number of revolutions, power consumption, and the like) of the power source to be tested are obtained. By determining whether the power source is normal based on the output characteristics, a failure power source can be detected. The locking operation of the power sources and obtaining of the output characteristics are performed in at least two combinations while switching the states of the power source to be tested. To be specific, with only one combination, when a failure is determined, the defective one of the two power sources which is operating cannot be specified. Therefore, the test is performed on a plurality of combinations of states of the power sources. If there is a combination including normal power sources, based on the information, a defective one of the power sources included in a combination determined as defective can be specified.

In the testing system of the present invention, in a state where power sources to be tested are mounted on a hybrid vehicle, locking and operation of the power sources is automatically controlled, and the output characteristics of the power source being operated are measured. That is, without detaching any of the power sources from the vehicle, the output characteristics of each of the power sources mounted on the vehicle are measured. The measured output characteristic is determined if it is normal. Therefore, the performance of each of the power sources in a hybrid vehicle in a final product form (a vehicle state) can be tested in a state where each power source is combined with the other hybrid units not only during manufacture of the vehicle but also at the end of manufacture (an initial state), during use (aging change) and, further, at the time of occurrence of a failure.

Examples of the combination of locking of a power source and acquisition of output characteristics are: a combination (combination 1A) in which the second motor is locked, the engine is operated with target torque, and the output characteristic of the first motor is obtained in a state where the first motor is operated by the number-of-revolutions control; and a combination (combination 1B) in which the first motor is locked, the engine is operated with target torque, and the output characteristic of the second motor is obtained in a state where the second motor is operated by the number-of-revolutions control.

By using such combinations, whether the first motor is normal can be determined in the combination 1A, and whether the second motor is normal can be determined in the combination 1B. Any one of the combinations 1A and 1B may be performed first. In both of the combinations, the engine is operated. Thus, in the case where a failure is determined in both of the combinations, that is, when both of the motors are defective, it can be estimated that the engine is defective. By performing the test with the above combinations, consequently, not only the motors but also the engine can be examined.

In addition, for example, a locking mechanism for locking the output shaft of the engine may be provided to perform the test with the following combinations for obtaining the output characteristics of at least one of the first and second motors. Specifically, in a combination (combination 2A), the engine is locked by the locking mechanism, the first motor is operated by torque control, and the second motor is operated by the number-of-revolutions control. In another combination (combination 2B), the engine is locked by the locking mechanism, the second motor is operated by the torque control, and the first motor is operated by the number-of-revolutions control.

By using such combinations, whether the first and second motors are normal can be determined. Any one of the combinations 2A and 2B may be performed first. In both of the combinations, the engine is locked, so that it is unnecessary to control the operation of the engine. That is, only the motors easy to control are caused to operate, and the output characteristic of each motor is obtained. Consequently, the output characteristic can be obtained with high precision, and the test can be conducted more accurately for each motor.

In the testing system of the present invention, more preferably, one of the first and second motors is set as a motor to be tested, and the other motor is set as a motor not to be tested (hereinafter, an untested motor). One of the engine and the untested motor is locked and the other one is operated. In this state, the back electromotive force of the motor to be tested is obtained. Based on the back electromotive force, whether the motor to be tested is normal is determined. Specifically, in the testing system, by making the motor to be tested run idle, the back electromotive force is obtained (a back electromotive force obtaining step). When the cause of the failure is electric one in the motor, the back electromotive force lies out of a reference range. Consequently, based on the back electromotive force, a failure of the motor due to an electric cause can be determined. That is, the cause of a failure can be specified more particularly.

In the testing system of the present invention, more preferably, one of the first and second motors is set as a motor to be tested, and the other motor is set as a motor which is not tested. One of the engine and the untested motor is locked and the other one is operated. In this state, drag torque of the motor to be tested is obtained. Based on the drag torque, whether the motor to be tested is normal is determined. Specifically, in the testing system, by locking one of the power sources which are not tested and operating the motor to be tested, drag torque is obtained (a drag torque obtaining step). When the cause of the failure is mechanical one in the motor, the drag torque lies outside a reference range. Consequently, based on the drag torque, a failure of the motor due to a mechanical cause can be determined. That is, the cause of a failure can be specified more particularly.

### BRIEF DESCRIPTION OF DRAWINGS

FIG. 1 is a diagram showing a system configuration of a hybrid vehicle in a preferred embodiment;

FIG. 2 is a diagram showing a configuration of a power transfer of a transaxle;

FIG. 3 is a table showing outline of testing methods for an output performance test;

FIG. 4 is a graph showing an example of a test point for the output performance test;

FIG. 5 is a flowchart (Part 1) showing procedures of the output performance test in a first mode;

FIG. 6 is a flowchart (Part 2) showing procedures of the output performance test in the first mode;

FIG. 7 is a flowchart (Part 1) showing procedures of the output performance test in a second mode;

FIG. 8 is a flowchart (Part 2) showing procedures of the output performance test in the second mode;

FIG. 9 is a diagram showing an example of a cause of failure;

FIG. 10 is a graph showing an example of a test point in a failure cause specifying test and of thresholds in a drag torque test;

FIG. 11 is a flowchart (Electrical failure 1) showing procedures of the failure cause specifying test;

FIG. 12 is a flowchart (Electrical failure 2) showing procedures of the failure cause specifying test;

FIG. 13 is a graph showing waveforms of back electromotive forces of a permanent magnet synchronous motor (3-phase AC motor);

FIG. 14 is a graph showing a normal pattern of the back electromotive force waveform;

FIG. 15 is a graph showing an abnormal pattern (entire failure) of the back electromotive force waveform;

FIG. 16 is a graph showing an abnormal pattern (partial failure) of the back electromotive force waveform;

FIG. 17 is a flowchart (Mechanical failure 1) showing procedures of the failure cause specifying test; and

FIG. 18 is a flowchart (Mechanical failure 2) showing procedures of the failure cause specifying test.

### BEST MODE FOR CARRYING OUT THE INVENTION

A detailed description of a preferred embodiment of the present invention will now be given referring to the accompanying drawings. In the present embodiment, the present invention is applied to a test system for hybrid vehicle mounted with a transaxle including two motors.

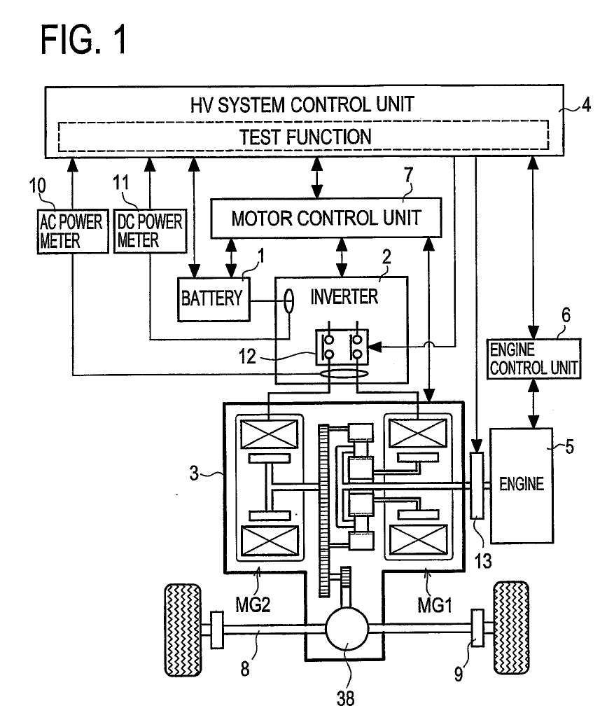

A hybrid vehicle 100 of the embodiment includes, as shown in FIG. 1, a battery 1, an inverter 2, a transaxle 3, a hybrid system control unit (an HV system control unit) 4, an engine 5, an engine control unit 6, a motor control unit 7, an output shaft 8, a brake 9, an AC power meter 10, a DC power meter 11, an electromagnetic switch 12 for connecting a motor power cable (hereinafter, referred to as a “switch” 12), and an engine shaft locking mechanism 13. The details of a basic system configuration and basic operation of a hybrid vehicle to be tested are described in, for example, JP2001-164960A.

The engine 5 is a well-known internal combustion engine using gasoline as fuel, and undergoes various drive controls such as fuel injection control, ignition control, and intake air volume adjusting control of the engine control unit 6. The engine control unit 6 performs communications with the HV system control unit 4 and controls the operation of the engine 5 according to a control signal from the HV system control unit 4. As necessary, the engine control unit 6 outputs data regarding the operating condition of the engine 5 to the HV system control unit 4.

The transaxle 3 has two motors MG1 and MG2, a power transfer 30, and a differential gear 38, and the motors MG1 and MG2 and the differential gear 38 are placed to be able to transfer power to each other via the power transfer 30. The motors MG1 and MG2 are a known synchronous generator-motor functioning as a generator and a motor. The motors MG1 and MG2 are electrically connected to the battery 1 via the switch 12 and the inverter 2. The motors MG1 and MG2 are controlled to operate by the motor control unit 7. The motor drive unit 7 can receive signals necessary for controlling the motors MG1 and MG2, for example, a signal from a rotation position sensor (not shown) for detecting the rotation position of a rotor of each of the motors MG1 and MG2. The motor control unit 7 can output a switching control signal to the inverter 2. The motor control unit 7 is arranged to communicate with the HV system control unit 4 and control the motors MG1 and MG2 in accordance with a control signal from the HV system control unit 4. Furthermore, as needed, the motor control unit 7 can output data regarding the operating condition of the motors MG1 and MG2 to the HV system control unit 4.

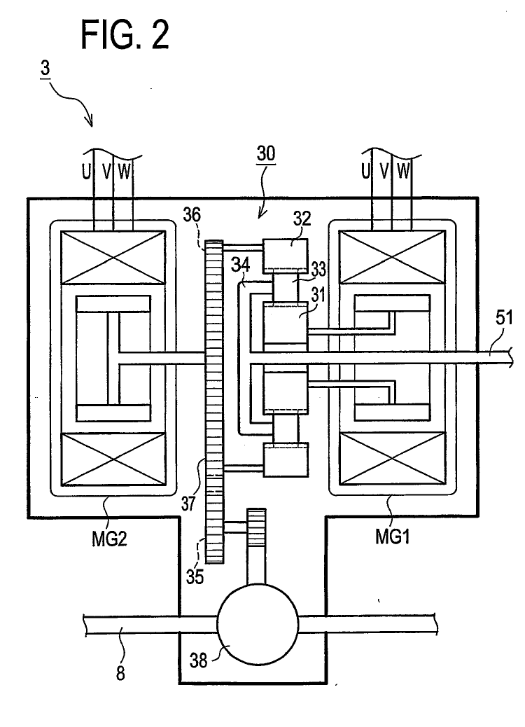

The power transfer 30 includes, as shown in FIG. 2, a sun gear 31 as an externally-toothed gear, a ring gear 32 as an internally-toothed gear disposed concentrically with the sun gear 31, a plurality of pinion gears 33 engaging with the sun gear 31 and the ring gear 32, and a carrier 34 supporting the pinion gears 33 so that the pinion gears 33 can rotate and revolute. The power transfer 30 is constructed as a planetary gear mechanism that differentially operates using the sun gear 31, the ring gear 32, and the carrier 34 as rotational elements. In the transaxle 3, a crankshaft 51 of the engine 5 is coupled to the carrier 34, the motor MG1 is coupled to the sun gear 31, and the motor MG2 is coupled to the ring gear 32. The ring gear 32 is coupled to a power take-off gear 36 for taking off power. The power take-off gear 36 is connected to a power transmission gear 35 via a chain belt 37. Power is thus transmitted between the power take-off gear 36 and the power transmission gear 35.

The HV system control unit 4 is connected to the engine control unit 6, the motor control unit 7, the battery 1, and others to transmit/receive various control signals to/from those units. Further, the HV system control unit 4 can receive measurement data of the DC power meter 11 for measuring DC current and DC voltage between the battery 1 and the inverter 2 and measurement data of the AC power meter 10 for measuring AC current and AC voltage between the inverter 2 and the transaxle 3. The HV system control unit 4 has not only the function of controlling operations of the whole vehicle system but also the testing function of controlling testing operation, performance determination, and the like.

The testing function of the HV system control unit 4 is executed in the vehicle state, for example, when some abnormal operation is detected in the hybrid vehicle 100 in a normal driving condition or when the operation condition of the hybrid vehicle 100 is switched to a stop state after the abnormal operation is detected. Concretely, the operation condition of the hybrid vehicle 100 is switched to the stop state, and a test switch or the like for starting a test mode is operated, starting the testing function. Thus, a test on the HV system is automatically executed. After a series of tests is executed, the testing operation is terminated automatically. A test result is output by turn-on of an abnormality lamp, transmission of data to a test diagnosis tool, and the like.

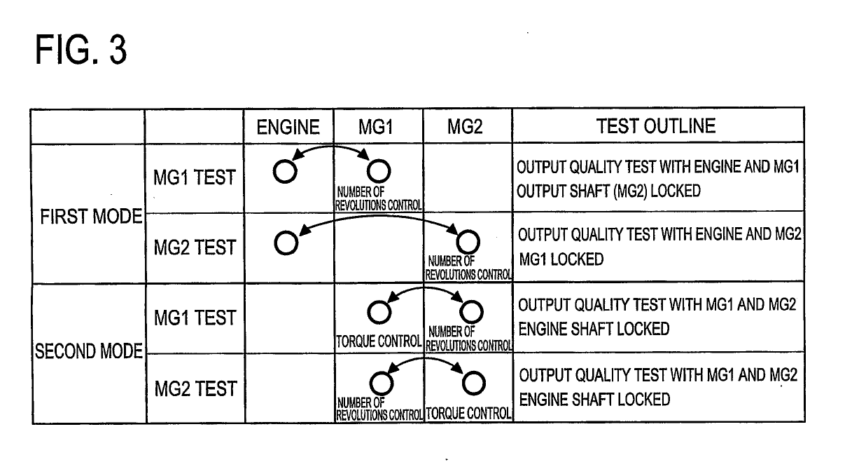

Two methods of testing the hybrid vehicle 100 by the HV system control unit 4 will be described. FIG. 3 is a table showing outline of the testing methods. In a first mode, a test is conducted in a manner such that the motor MG2 is locked and the engine 5 and the motor MG1 are operated with predetermined test parameters or conditions, and another test is conducted in a manner such that the motor MG1 is locked and the engine 5 and the motor MG2 are operated with predetermined test parameters. Specifically, the engine 5 and one of the motors in the transaxle 3 are operated at a predetermined operation point, and output torque of the operated motor is measured. It is then determined whether or not the measured value lies in a target range. In a second mode, on the other hand, a test is conducted in a manner such that the output shaft of the engine 5 is locked, and the motors MG1 and MG2 are operated with predetermined test parameters. Specifically, both of the motors in the transaxle 3 are operated at a predetermined operation point with predetermined parameters, and output torque of one of the motors is measured. It is then determined whether or not the measured value lies in a target range.

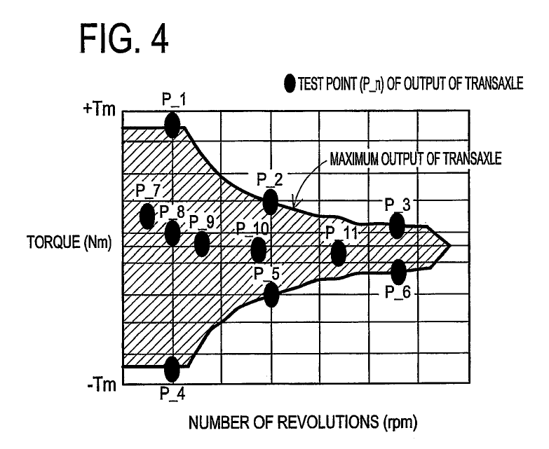

Prior to the test, a test point at which predetermined test parameters are satisfied is set. FIG. 4 is a graph showing an example of setting of a test point (P_n). The vertical axis in FIG. 4 indicates output torque (unit: Nm) of the transaxle 3. The horizontal axis in FIG. 4 indicates output revolutions (unit: rpm) of the transaxle 3. The test point is set by specifying the target test torque and target number of revolutions. The curve in FIG. 4 shows the maximum output torque of the transaxle 3 during output operation, that is, it shows the relation between the number of revolutions and the maximum output torque. A hatched region on the left side of the curve indicates an entire operation region of the transaxle 3. A test point is arbitrarily set according to a purpose in the entire operation region of the transaxle 3.

<Output Performance Test (First Mode)>

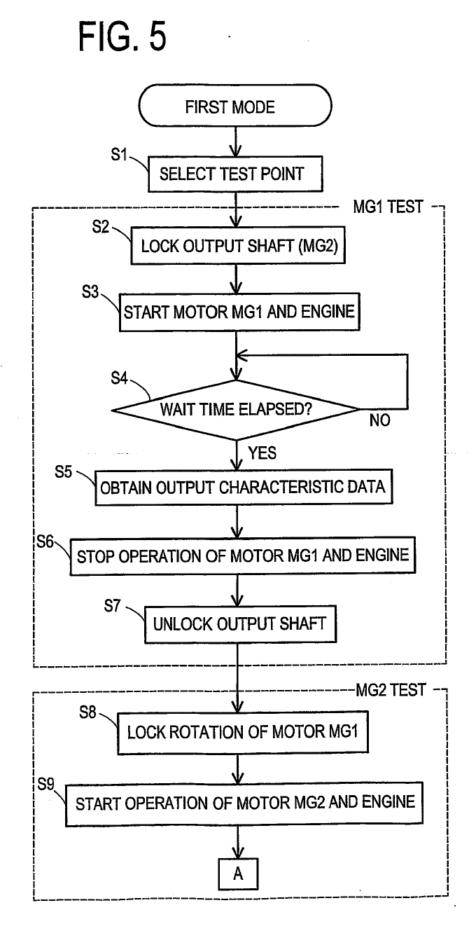

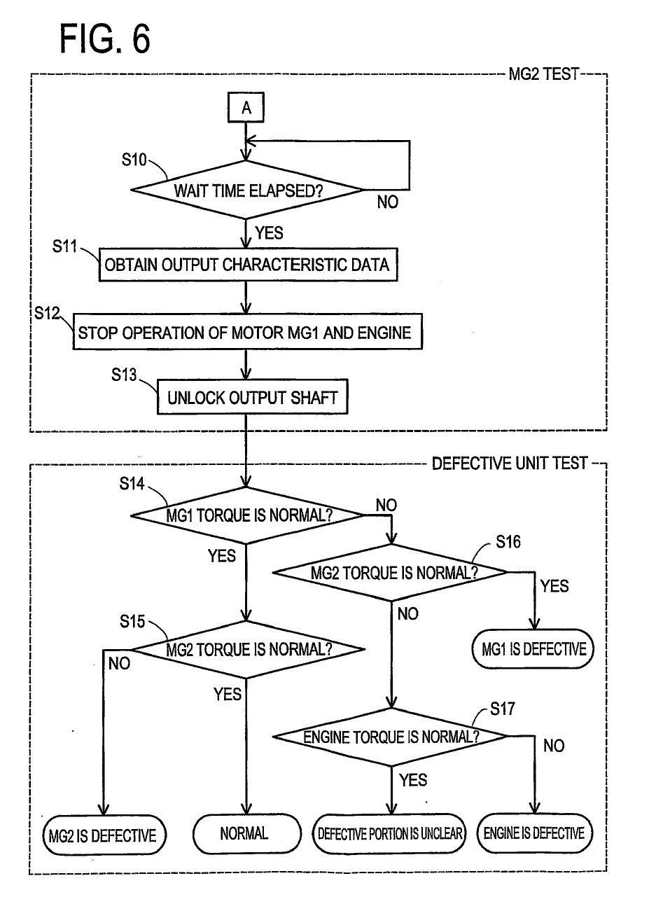

The procedure of an output performance test on the transaxle 3 will be described below with reference to the flowcharts of FIGS. 5 and 6. The test is conducted in order by testing the motor MG1 (S2 to S7), testing the motor MG2 (S8 to S13), and determining a defective unit (S14 to S17). Any of the test of the motor MG1 and the test of the motor MG2 may be performed first. The test is conducted on the transaxle 3 and it is assumed that the other units (particularly, the engine 5) are normal.

First, one test point (P_n) is selected from preset test points (S1). The test point selecting order is preset, and the test points are automatically selected in the preset order. The setting of the selecting order is arbitrary. Alternatively, the selecting order can be arbitrarily set by a tester for each test. Table 1 shows main items which are set at the test point (P_n).

TABLE 1

| TARGET NUMBER OF | | | |
|---|---|---|---|
| REVOLUTIONS | | TARGET TORQUE | |
| Ne*: | Target number of | Te*: | Target torque of engine |
| | revolutions of engine | | |
| Nmg1*: | Target number of | Tmg1*: | Target torque of motor |
| | revolutions of motor MG1 | | MG1 |
| Nmg2*: | Target number of | Tmg2*: | Target torque of motor |
| | revolutions of motor MG2 | | MG2 |

Next, a test of the motor MG1 is conducted. At the time of conducting the test of the motor MG1, first, the output shaft 8 of the transaxle 3 is locked (S2). In the test of the motor MG1, the motor MG1 is operated together with the engine 5, and output characteristics of the motor MG1 are measured. The motor MG1 is coupled to the engine 5 via the pinion gear 33. Consequently, if the output shaft 8 side (that is, the motor MG2 side) is not locked by some means, torque is transmitted to the ring gear 32 side coupled via the pinion gear 33, allowing the vehicle to move or the output shaft 8 to run idle. Thus, accurate torque cannot be measured. To avoid such disadvantage, when the motor MG1 is to be tested, it is necessary to lock components between the ring gear 32 and the shaft 8 in the torque transmitting direction.

For example, there are the following two methods of locking the output shaft 8. One of them is an electric locking method of performing lock control in the motor MG2. Specifically, position control is performed so as to maintain the current position of the motor MG2. Alternatively, by DC energization, stationary operation is performed without permitting rotation. The other method is a mechanical locking method using the brake 9. That is, the output shaft 8 is locked by braking means such as a parking brake.

Based on the parameters at the selected test point (P_n), the motor MG1 and the engine 5 are operated (S3). Specifically, fuel injection control is performed on the engine 5 so that the torque becomes target torque Te*. The motor MG1 applies load torque to the engine 5 so that the number of revolutions of the engine 5 is controlled to become “target number of revolutions” Ne*. Concretely, torque for controlling the number of revolutions of the motor MG1 is calculated by the following arithmetic expression (1) to accelerate or decelerate the motor MG1, thereby adjusting the “number of revolutions” Ne of the engine 5.

Tmg1=(Ne*−Ne)×Kp+(Ne*−Ne)×Ki+Te* (1)

where Tmg1 denotes control torque of the motor MG1, Ne* denotes the target number of revolutions of the engine 5, Ne denotes the actual number of revolutions of the engine 5, Kp denotes proportional control gain, Ki indicates integral control gain, and Te* indicates target torque of the engine 5.

In S4, successively, it is determined whether or not a preset wait time has elapsed since the start of the process in S3. The process of S4 is necessary for a reason that the output torque and the number of revolutions immediately after the engine 5 or motor MG1 starts outputting the torque are in a transient period, and it is difficult to stably measure the output characteristics. Consequently, after a lapse of the wait time (YES in S4), the program shifts to the process of S5. On the other hand, when the wait time has not elapsed (NO in S4), the process of S4 is repeated. When the output stable state is obtained after the operation transition period, the output torque Te of the engine 5 and the motor torque Tmg1 of the motor MG1 become equal to each other. The output torque in this state is the test torque of the motor MG1.

Successively, in a state where the torque is output, the output characteristics data is obtained (S5). In the present embodiment, control data of the motor MG1 is obtained. Concretely, the control torque Tmg1 of the motor MG1 used in the process of S3 is obtained and recorded in the HV system control unit 4.

Whether the motor is normal can also be determined by the number of revolutions of the motor MG1. Consequently, the actual “number of revolutions” Nmg1 of the motor MG1 may be obtained. In this case, a signal from a revolution position sensor of the motor MG1 is obtained by the motor control unit 7, and the “number of revolutions” Nmg1 of the motor MG1 is calculated based on the signal.

Whether the motor is normal can be determined also by power supplied to the motor MG1. Consequently, power supplied to the motor MG1 may be measured. In this case, power of direct current flowing between the DC power supply 1 and the inverter 2 is measured by the DC power meter 11. Concretely, voltage (Vdc_mg1), current (Idc_mg1), and power (Pdc_mg1) of the motor MG1 are measured. Alternatively, power of alternating current flowing between the inverter 2 and the motor MG1 is measured by the AC power meter 10. Concretely, voltage (Vac_mg1), current (Iac_mg1), and power (Pac_mg1) are measured.

After the output torque Tmg1 of the motor MG1 is recorded, the outputting operation of the engine 5 and the motor MG1 is stopped to terminate the operation of testing the motor MG1 (S6). After the operation of testing the motor MG1 is terminated, the output shaft 8 is unlocked (S7). The test of the motor MG1 is thus completed. After that, the program shifts to a test of the motor MG2.

Then, a test of the motor MG2 is conducted. When a test of the motor MG2 is to be conducted, first, the motor MG1 is locked. (S8). In the test of the motor MG2, the motor MG2 is operated together with the engine 5, and the output characteristics of the motor MG2 are measured. The motor MG2 at this time is not directly coupled to the engine 5 but is coupled to the engine 5 via the pinion gear 33. Consequently, when the motor MG1 is in a unloaded condition, very little torque is transmitted between the engine 5 and the motor MG2, and the motor MG2 cannot be tested. During the test of the motor MG2, therefore, the motor MG1 has to be subjected to the lock control so as to be placed in a fixed state.

The lock control for the motor MG1 includes a method of performing position control so as to maintain the current position of the motor MG1 and a method of performing stationary operation by DC energization without permitting rotation.

Based on the parameters at the selected test point (P_n), the motor MG2 and the engine 5 are operated (S9). Specifically, fuel injection control is performed on the engine 5 so that the torque becomes the target torque Te*. The motor MG2 applies load torque to the engine 5 so that the number of revolutions of the engine 5 is controlled to become target “number of revolutions” Ne*. Concretely, torque for controlling the number of revolutions of the motor MG2 is calculated by the following arithmetic expression (2) to accelerate or decelerate the motor MG2, thereby adjusting the number of revolutions Ne of the engine 5.

Tmg2=(Ne*−Ne)×Kp+(Ne*−Ne)×Ki+Te* (2)

where Tmg2 denotes control torque of the motor MG2, Ne* denotes the target number of revolutions of the engine 5, Ne denotes the actual number of revolutions of the engine 5, Kp denotes proportional control gain, Ki indicates integral control gain, and Te* indicates target torque of the engine 5.

In S10, successively, it is determined whether a preset wait time has elapsed since the start of the process in S9. When the wait time has elapsed (YES in S10), the program shifts to the process of S11. On the other hand, when the wait time has not elapsed (NO in S10), the process of S10 is repeated. When the output stable state is obtained after the operation transition period, the output torque Te of the engine 5 and the motor torque Tmg2 of the motor MG2 become equal to each other. The output torque in this state is the test torque of the motor MG2.

In a state where the torque is output, the output characteristics data is obtained (S11). In the present embodiment, control data of the motor MG2 is acquired. Concretely, the control torque Tmg2 of the motor MG2 used in the process of S9 is obtained and recorded in the HV system control unit 4. As the output characteristics data of the motor MG2, the number of revolutions Nmg2 of the motor MG2 or power supplied to the motor MG2 may be used.

After the output torque Tmg2 of the motor MG2 is recorded, the outputting operation of the engine 5 and the motor MG2 is stopped to terminate the operation of testing the motor MG2 (S12). After the operation of testing the motor MG2 is terminated, the motor MG1 is unlocked (S13). The test of the motor MG2 is thus completed. After that, the program shifts to discrimination of a defective unit.

Next, a defective unit will be discriminated. The output torque Tmg1 of the motor MG1 is first determined (S14). Concretely, a check is made to see whether the output torque Tmg1 lies in the range between an upper limit Tmg1U and a lower limit Tmg1L which are set in advance in accordance with the parameters of the selected test point (P_n).

When the output torque Tmg1 of the motor MG1 lies in the normal range (YES in S14), the output torque Tmg2 of the motor MG2 is checked (S15). Concretely, it is determined whether the output torque Tmg2 comes within the range between an upper limit Tmg2U and a lower limit Tmg2L which are set in advance in accordance with the parameters of the selected test point (P_n).

When the output torque Tmg2 of the motor MG2 lies in the normal range (YES in S15), it is determined that both of the motors MG1 and MG2 in the transaxle 3 are normal. When the output torque Tmg2 of the motor MG2 is out of the normal range (NO in S15), indicating that the motor MG1 is normal, it is determined that the motor MG2 is abnormal.

When the output torque Tmg1 of the motor MG1 lies out of the normal range (NO in S14), in a manner similar to the process of S15, the output torque Tmg2 of the motor MG2 is checked (S16). When the output torque Tmg2 of the motor MG2 is in the normal range (YES in S16), indicating that the motor MG1 is abnormal, it is determined that the motor MG1 is abnormal.

When the output torque Tmg2 of the motor MG2 lies out of the normal range (NO in S16), both of the motors MG1 and MG2 in the transaxle 3 are considered as abnormal. However, the engine 5 operates in both of the test of the motor MG1 and the test of the motor MG2. Consequently, when the engine 5 is abnormal, both of the motors MG1 and MG2 are considered to be defective. It is therefore determined whether the engine 5 is normal (S17). When the engine 5 is normal, the target torque Te* of the engine 5 is supposed to be equal to the output torque Tmg1 of the motor MG1 and the output torque Tmg2 of the motor MG2. Accordingly, the target torque Te* of the engine 5 is compared with the output torque Tmg1 of the motor MG1 (or the output torque Tmg2 of the motor MG2). When the target torque Te* of the engine 5 does not coincide with the output torque of the motor MG1 (or motor MG2) (NO in S17), it is determined that the engine 5 is abnormal. On the other hand, when the target torque Te* of the engine 5 coincides with the output torque of the motor MG1 or MG2 (YES in S17), the defective portion which is in the motor MG1 or MG2, in the engine 5, or in the others cannot be specified. It is thus determined that a defective portion is unclear. This means that all of the motors MG1 and MG2 and the engine 5 are defective or another unit is defective.

<Output Performance Test (Second Mode)>

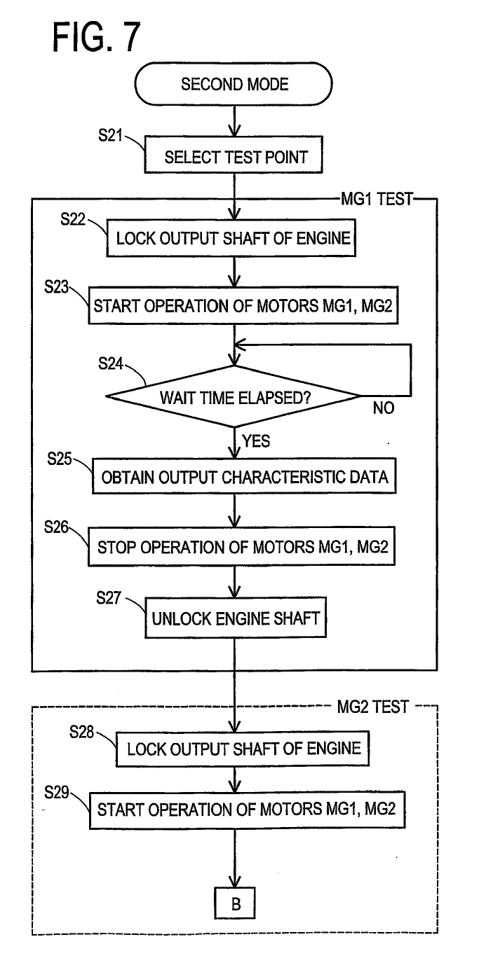

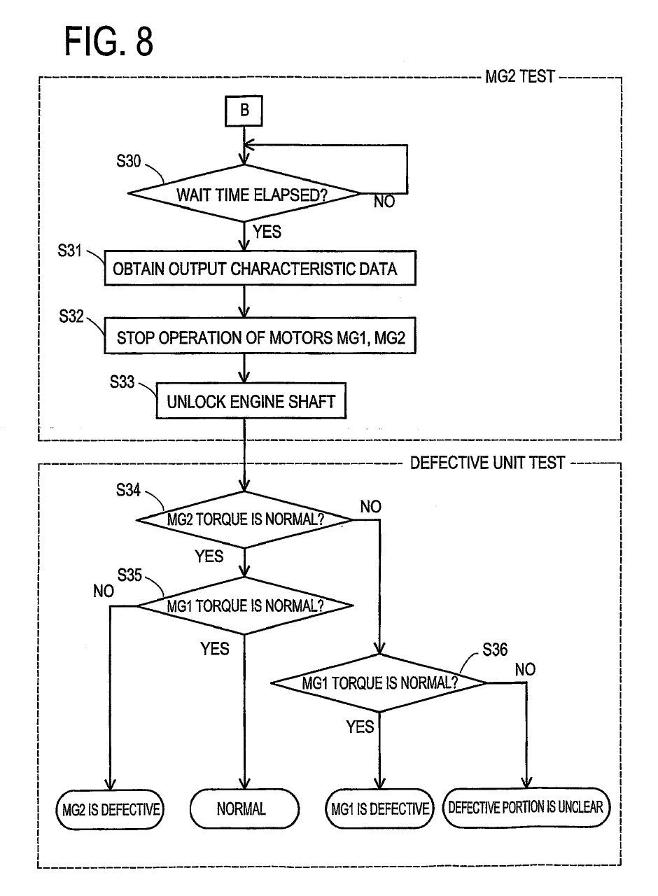

The procedure of an output performance test on the transaxle 3 will be described below with reference to the flowcharts of FIGS. 7 and 8. The test is conducted in order by testing the motor MG1 (S22 to S27), testing the motor MG2 (S28 to S33), and determining a defective unit (S34 and S35). Any of the test of the motor MG1 and the test of the motor MG2 may be performed first.

First, one test point (P_n) is selected from preset test points (S21). The test point selecting order is preset, and the test points are automatically selected in the preset order. The setting of the selecting order is arbitrary. The selecting order can be arbitrarily set by a tester for each test. Table 2 shows main items which are set at the test point (P_n).

TABLE 2

| TARGET NUMBER OF | | | |
|---|---|---|---|
| REVOLUTIONS | | TARGET TORQUE | |
| Nmg1*: | Target number of | Tmg1*: | Target torque of motor |
| | revolutions of motor MG1 | | MG1 |
| Nmg2*: | Target number of | Tmg2*: | Target torque of motor |
| | revolutions of motor MG2 | | MG2 |

Next, a test of the motor MG1 is conducted. When the test of the motor MG1 is to be conducted, first, the output shaft of the motor 5 is locked (S21). In the test of the motor MG1, control for the number of revolutions of the motor MG2 and control for the torque of the motor MG1 are performed. The motor MG1 is coupled to the engine 5 and the motor MG2 via the pinion gear 33. Consequently, to output the torque of the motor MG1 to the motor MG2, if the output shaft of the engine 5 is not locked by some means, torque will be transmitted to the output shaft of the engine 5, thereby causing the output shaft of the engine 5 to run idle, so that the torque cannot be measured accurately. Therefore, in the test of the motor MG1, the output shaft of the engine 5 has to be locked by the engine shaft locking mechanism 13.

As the engine shaft locking mechanism 13, any mechanism may be used as long as it can lock the shaft coupling the engine 5 and the motor MG1. For example, an electromagnetic brake structure or a mechanical locking method such as a parking brake mechanism can be adopted.

Based on the parameters at the selected test point (P_n), control for the number of revolutions of the motor MG2 and the torque control for the motor MG1 are executed (S23). Specifically, the torque of the motor MG1 is controlled so as to reach the target torque Tmg1*. The number of revolutions of the motor MG2 is controlled so that the number of revolutions of the motor MG1 becomes the target number of revolutions Nmg1*. Concretely, torque for controlling the number of revolutions of the motor MG2 is calculated by the following arithmetic expression (3) to accelerate or decelerate the motor MG2, thereby adjusting the number of revolutions Nmg1 of the motor MG1.

Tmg2=(Nmg2*−Nmg2)×Kp+(Nmg2*−Nmg2)×Ki (3)

where Tmg2 denotes control torque of the motor MG2, Nmg2* denotes the target number of revolutions of the motor MG2, Nmg2 denotes the actual number of revolutions of the motor MG2, Kp denotes proportional control gain, and Ki indicates integral control gain.

In S24, it is determined whether a preset wait time has elapsed since the start of the process in S23. When the wait time has elapsed (YES in S24), the program shifts to the process of S25. On the other hand, when the wait time has not elapsed (NO in S24), the process of S24 is repeated. When the output stable state is obtained after the operation transition period, the output torque Tmg2 of the motor MG2 and the motor torque Tmg1 of the motor MG1 as a load torque on the motor MG2 become equal to each other. The torque control value in this state is the test torque of the motor MG1.

In a state where the torque is output, successively, the output characteristics data is obtained (S25). In the embodiment, control data of the motor MG2 is obtained. Concretely, the control torque Tmg2 of the motor MG2 used in the process of S23 is obtained and recorded in the HV system control unit 4. As the output characteristics data of the motor MG1, the number of revolutions Nmg1 of the motor MG1 or power supplied to the motor MG1 may be used.

After recording the output torque Tmg2 of the motor MG2, the outputting operation of the motors MG2 and MG1 is stopped to terminate the operation of testing the motor MG1 (S26). After the testing operation of the motor MG1 is terminated, the engine shaft locking mechanism 13 is unlocked (S27). The test of the motor MG1 is thus completed. After that, the program shifts to a test of the motor MG2.

Then, a test of the motor MG2 is conducted. When the test of the motor MG2 is to be conducted, first, the output shaft of the engine 5 is locked (S28). In the test of the motor MG2, control for the number of revolutions of the motor MG1 and control for the torque of the motor MG2 are performed. The motor MG2 at this time is coupled to the engine 5 and the motor MG1 via the pinion gear 33. Consequently, to output the torque of the motor MG2 to the motor MG1, if the output shaft of the engine 5 is not locked by some means, the torque will be transmitted to the output shaft of the engine, causing the output shaft of the engine 5 to run idle, so that the torque cannot be measured accurately. Therefore, in the test of the motor MG2, the output shaft of the engine 5 has to be locked by the engine shaft locking mechanism 13.

Based on the parameters at the selected test point (P_n), control for the number of revolutions of the motor MG1 and control for the torque of the motor MG2 are executed (S29). Specifically, the torque of the motor MG2 is controlled so as to reach the target torque Tmg2*. The number of revolutions of the motor MG1 is controlled so that the number of revolutions of the motor MG2 becomes the target number of revolutions Nmg2*. Concretely, torque for controlling the number of revolutions of the motor MG1 is calculated by the following arithmetic expression (4) to accelerate or decelerate the motor MG1, thereby adjusting the number of revolutions Nmg2 of the motor MG2.

Tmg1=(Nmg1*−Nmg1)×Kp+(Nmg1*−Nmg1)×Ki (4)

where Tmg1 denotes control torque of the motor MG1, Nmg1* denotes the target number of revolutions of the motor MG1, Nmg1 denotes the actual number of revolutions of the motor MG1, Kp denotes proportional control gain, and Ki indicates integral control gain.

In S30, subsequently, it is determined whether a preset wait time has elapsed since the start of the process in S29. When the wait time has elapsed (YES in S30), the program shifts to the process of S31. On the other hand, when the wait time has not elapsed (NO in S30), the process of S30 is repeated. When the output stable state is obtained after the operation transition period, the output torque Tmg1 of the motor MG1 and the motor torque Tmg2 of the motor MG2 as a load torque to the motor MG1 become equal to each other. The torque control value in this state is the test torque of the motor MG2.

In a state where the torque is output, the output characteristic data is obtained (S31). In the present embodiment, control data of the motor MG1 is obtained. Concretely, the control torque Tmg1 of the motor MG1 used in the process of S29 is obtained and recorded in the HV system control unit 4. As the output characteristic data of the motor MG2, the number of revolutions Nmg2 of the motor MG2 or power supplied to the motor MG2 may be used.

After the output torque Tmg1 of the motor MG1 is recorded, the outputting operation of the motors MG1 and MG2 is stopped to terminate the operation of testing the motor MG2 (S32). After the operation of testing the motor MG2 is terminated, the engine shaft locking mechanism 13 is unlocked (S33). The test of the motor MG2 is thus completed. After that, the program shifts to discrimination of a defective unit.

Next, a defective unit will be discriminated. First, as determination of whether the motor MG1 is normal, the output torque Tmg2 of the motor MG2 obtained in the process of S25 is checked (S34). Concretely, it is determined whether the output torque Tmg2 lies in the range between an upper limit Tmg2U and a lower limit Tmg2L which are set in advance in accordance with the parameters of the selected test point (P_n).

When the output torque Tmg2 of the motor MG2 lies in the normal range (YES in S34), it is then determined whether the motor MG2 is normal by checking the output torque Tmg1 of the motor MG1 obtained in the process of S31 (S35). Concretely, it is determined whether the output torque Tmg1 lies in the range between an upper limit Tmg1U and a lower limit Tmg1L which are set in advance in accordance with the parameters of the selected test point (P_n).

When the output torque Tmg1 of the motor MG1 lies in the normal range (YES in S35), it is determined that both of the motors MG1 and MG2 in the transaxle 3 are normal. When the output torque Tmg1 of the motor MG1 obtained in the test of the motor MG2 is out of the normal range (NO in S35), it is determined that the motor MG2 is abnormal.

When the output torque Tmg2 of the motor MG2 obtained in the test of the motor MG1 lies out of the normal range (NO in S34), whether only the motor MG1 is defective or not cannot be specified at this stage. Even when the output torque Tmg2 of the motor MG2 is out of the normal range, the output torque Tmg1 of the motor MG1 is checked (S36). When the output torque Tmg1 of the motor MG1 is in the normal range (YES in S36), showing that the motor MG2 is normal, it is determined that the motor MG1 is abnormal. On the other hand, when the output torque Tmg1 of the motor MG1 is out of the normal range (NO in S36), the defective position which is in the motors MG1 and MG2 or in the other place cannot be specified, so that it is determined that a defective portion is unclear. This means that both of the motors MG1 and MG2 are defective or another unit is defective.

The two methods of testing the hybrid vehicle 100 have been described above. In the first mode, as shown in FIG. 3, a test is conducted in a state where the motors of the transaxle 3 and the engine 5 are combined. Consequently, the output performance of the motors MG1 and MG2 and, in addition, the engine 5 can be tested in a vehicle state. Different from the second mode, the first mode has an advantage that the engine shaft locking mechanism 13 is unnecessary, and the performance of the engine 5 can be also tested. On the other hand, in the second mode, the output shaft of the engine 5 is locked by the engine shaft locking mechanism 13, and a test is conducted in a state where the motors MG1 and MG2 of the transaxle 3 are combined. Consequently, the output performance test of the motors MG1 and MG2 can be conducted in a vehicle state. In addition, the test is conducted between the motors MG1 and MG2 whose torque control is easy. As compared with the first mode, therefore, a high-precision test can be performed without accompanying output control of the engine 5.

Although the operations at one test point have been described above, a plurality of test points may be selected. In such a case, after specifying a defective unit, the program returns to the process of S1, and another test point is selected. By repeating the processes, tests can be conducted at a plurality of test points.

<Failure Cause Specifying Test>

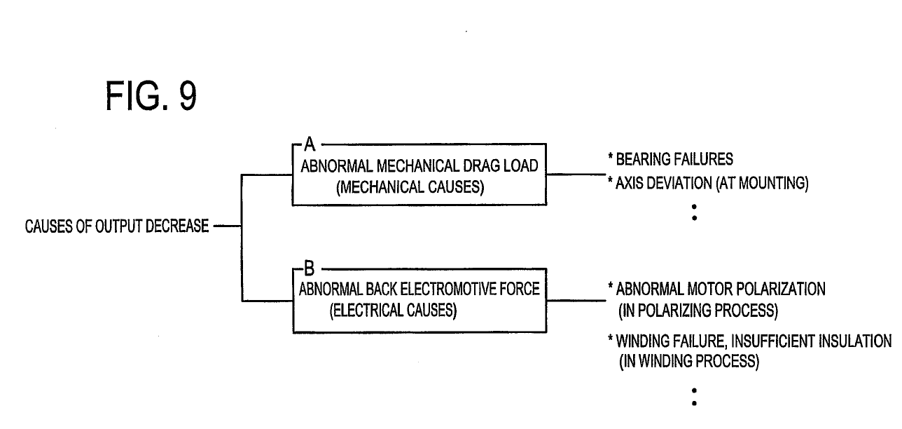

A failure cause specifying test of the motors MG1 and MG2 in the transaxle 3 will now be described. When the motor MG1 or MG2 is determined as a failure unit in the output performance test, a failure cause specifying test is conducted to specify the cause of the failure. Concretely, the causes of failures of the motor are classified into “A. abnormal mechanical drag load (mechanical causes)” and “B. abnormal back electromotive force (electrical causes)” as shown in FIG. 9, and a test is conducted.

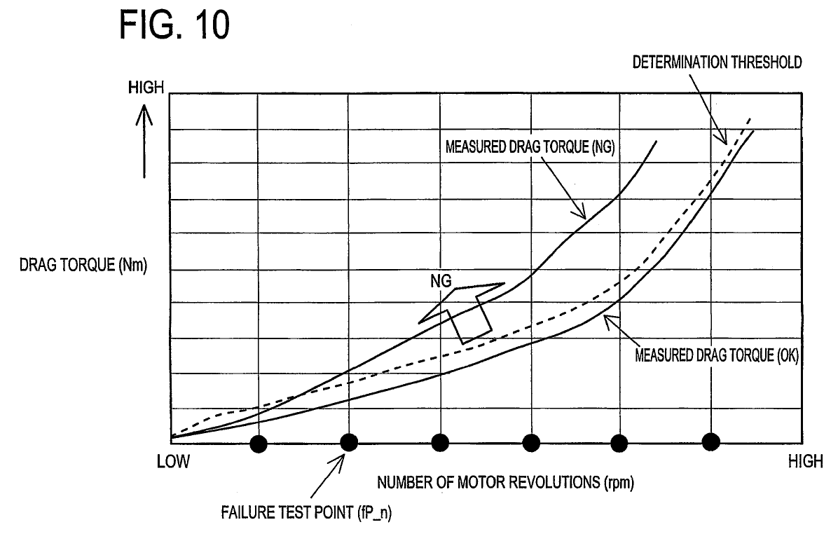

Prior to start of a test, a test point for a failure cause specifying test is set in advance. FIG. 10 is a graph showing an example of setting of a failure test point (fP_n) for testing a failure due to a mechanical cause of the motor. The vertical axis in FIG. 10 indicates drag torque (unit: Nm). The horizontal axis in FIG. 10 indicates the number of revolutions (unit: rpm) of the motor. The failure test point is arbitrarily set according to a purpose from the numbers of revolutions in the operation range of each motor.

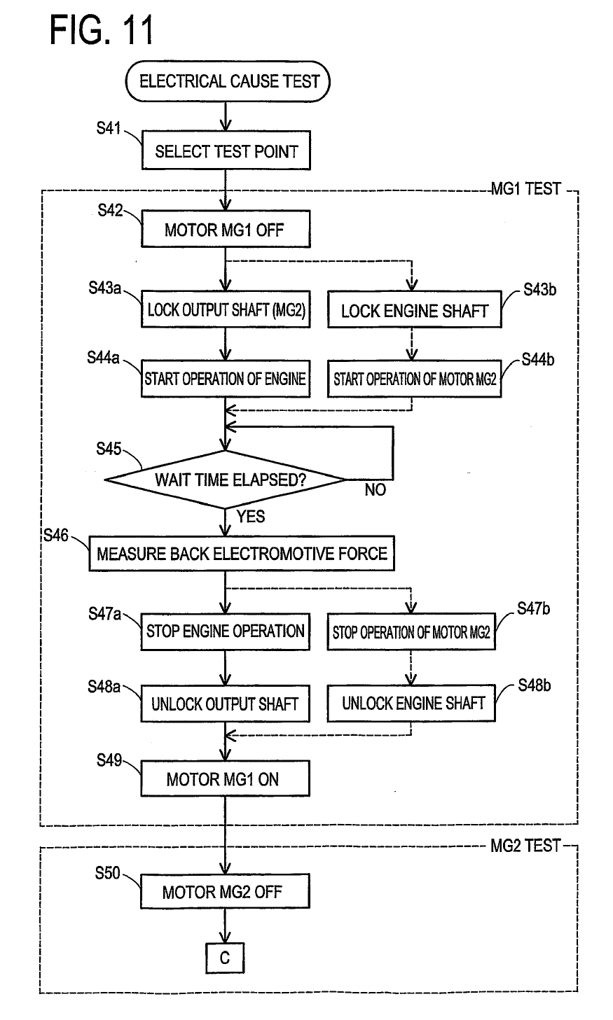

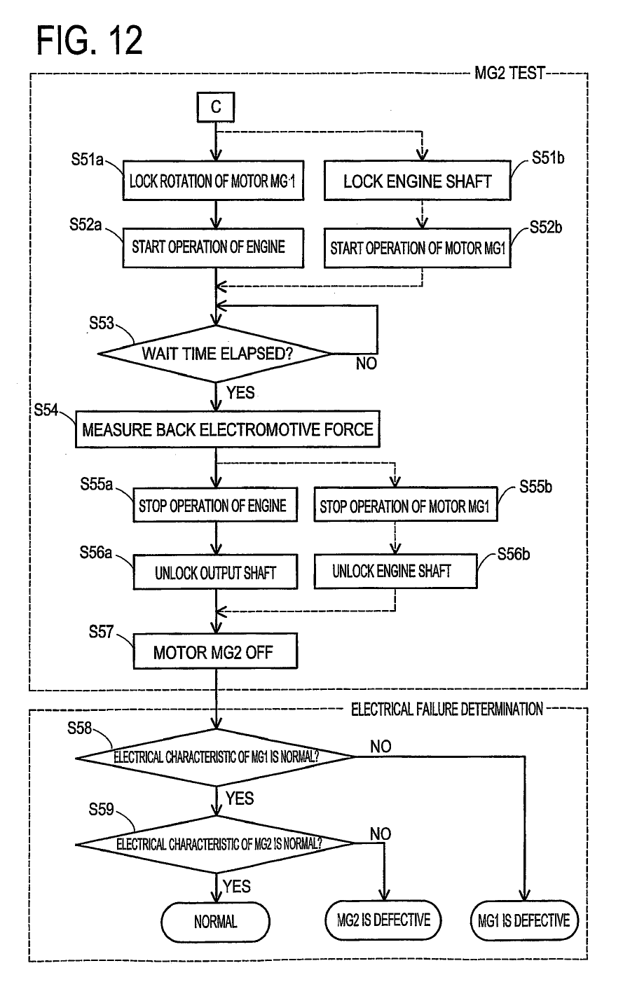

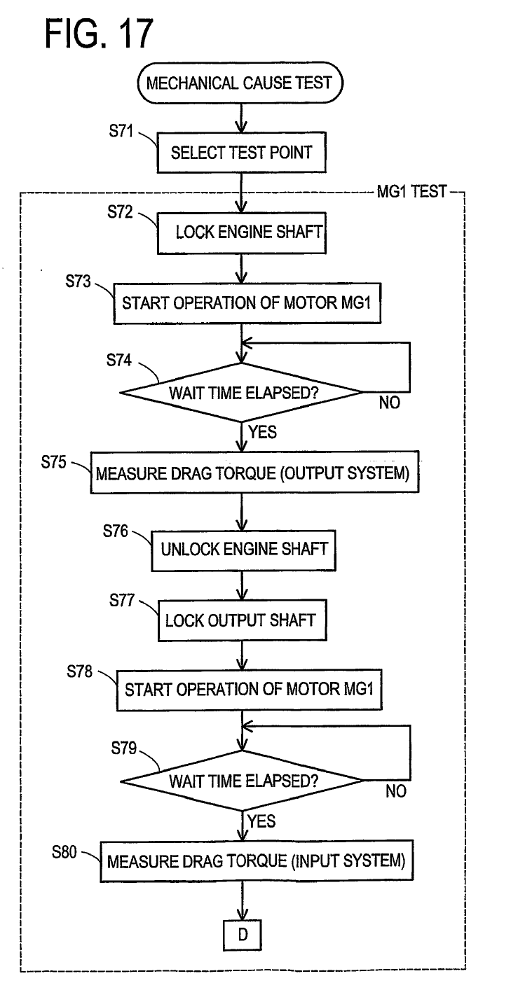

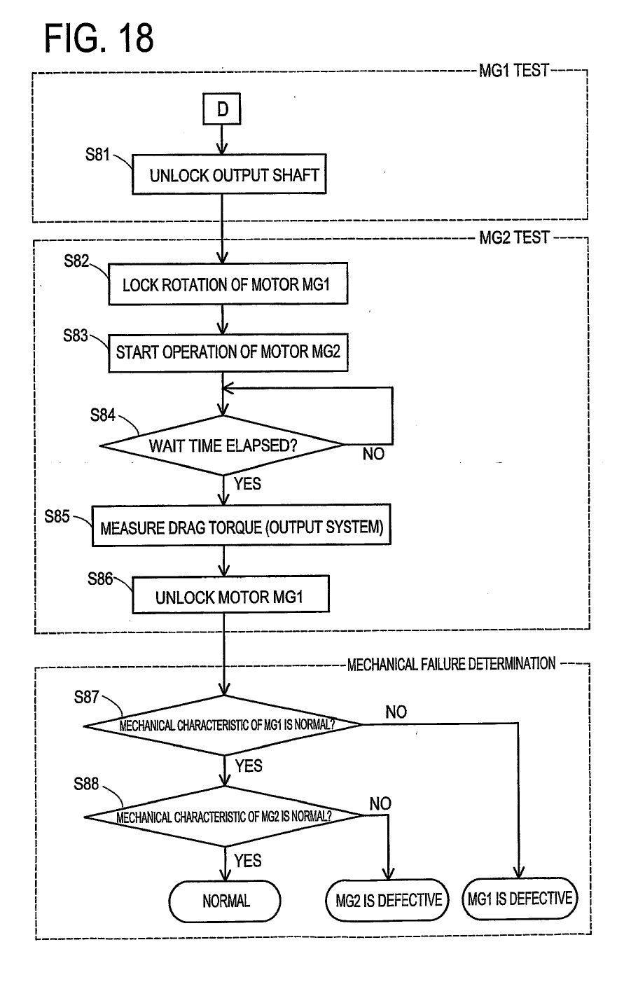

The procedure of a test for specifying the cause of a failure in a motor will be described below with reference to the flowcharts of FIGS. 11 and 12 (an electrical cause test) and FIGS. 17 and 18 (a mechanical cause test). In the present embodiment, the electrical cause test and the mechanical cause test are conducted in order. Any of the electrical cause test and the mechanical cause test may be performed first.

First, the electrical cause test (FIGS. 11 and 12) will be described. In the electrical cause test, a test of the motor MG1 (S42 to S49), a test of the motor MG2 (S50 to S57), and determination of a defective motor (S58 and S59) are performed in order. Any of the test of the motor MG1 and the test of the motor MG2 may be performed first. A motor determined as a nondefective product does not have to be tested.

One failure test point (fP_n) is selected from preset failure test points (S41). The failure test point selecting order is preset, and the test points are automatically selected in the preset order. The setting of the selecting order is arbitrary. The selecting order can be arbitrarily set by a tester for each test. Table 3 shows main items which are set at the failure test point (fp_n).

TABLE 3
TARGET NUMBER OF REVOLUTIONS

| | |
|---|---|
| Ne*: | Target number of revolutions of engine |
| Nmg1*: | Target number of revolutions of motor MG1 |
| Nmg2*: | Target number of revolutions of motor MG2 |

Successively, a test of the motor MG1 is conducted. To test the electrical characteristic of the motor MG1, the electric connection between the motor MG1 and the inverter 2 is switched to the OFF state by the switch 12 (S42). In a state where the motor MG1 and the inverter 2 are electrically connected to each other, back electromotive force cannot be measured with high precision due to the influence of the inverter circuit.

The motor MG1 is made run idle and the back electromotive force waveform of the motor MG1 is measured. For example, there are the following two methods of idle running. In one of them (a first method), the output shaft 8 of the transaxle 3 is locked and idle running is made by the torque of the engine 5. In the other method (a second method), the output shaft of the engine 5 (the input shaft of the transaxle 3) is locked and idle running is made by the torque of the motor MG2.

In the case of making the motor MG1 run idle by the first method, the output shaft 8 is locked (S43a). Since the motor MG1 is coupled to the engine 5 via the pinion gear 33, if components between the ring gear 32 and the output shaft 8 in the torque transmitting direction are not locked, the torque of the engine 5 will not be transmitted to the motor MG1. Consequently, the output shaft 8 or the motor MG2 has to be mechanically locked. Methods of locking the output shaft 8 include an electrical locking method of performing lock control in the motor MG2 and a mechanical locking method using the brake 9.

Based on the parameters at the selected failure test point (fP_n), the engine 5 is operated (S44a), thereby allowing the motor MG1 to run idle. In the engine 5, fuel injection control according to the target number of revolutions Ne* is performed. Concretely, arithmetic control is performed by the following arithmetic expression (5):

Te=(Ne*−Ne)×Kp+(Ne*−Ne)×Ki (5)

where Te denotes engine speed control torque, Ne* denotes the target number of revolutions of the engine 5, Ne denotes the actual number of revolutions of the engine 5, Kp denotes proportional control gain, and Ki indicates integral control gain.

In the case of making the motor MG1 run idle by the second method, the output shaft of the engine 5 is locked (S43b). Since the motor MG1 is coupled to the motor MG2 via the pinion gear 33, if the output shaft of the engine 5 (the input shaft of the transaxle 3) is not locked, the torque of the motor MG2 will not be transmitted to the motor MG1. Consequently, the output shaft of the engine 5 has to be mechanically locked. The output shaft of the engine 5 is locked by the engine shaft locking mechanism 13.

Based on the parameters at the selected failure test point (fp_n), the motor MG2 is operated (S44b), thereby allowing the motor MG1 to run idle. In the motor MG2, the number of revolutions is controlled according to the target number of revolutions Nmg2*. Concretely, arithmetic control is performed by the following arithmetic expression (6):

Tmg2=(Nmg2*−Nmg2)×Kp+(Nmg2*−Nmg2)×Ki (6)

where Tmg2 denotes engine speed control torque of the motor MG2, Nmg2* denotes the target number of revolutions of the motor MG2, Nmg2 denotes the actual number of revolutions of the motor MG2, Kp denotes proportional control gain, and Ki indicates integral control gain.

Successively, it is determined whether a preset wait time has elapsed since the start of the process in S44a or S44b or not (S45). When the wait time has elapsed (YES in S45), the program shifts to the process of S46. On the other hand, when the wait time has not elapsed (NO in S45), the process of S45 is repeated.

As the electric characteristic of the motor MG1, back electromotive force Vmg1 of the motor MG1 at the time when the engine 5 or motor MG2 reaches the target number of revolutions is measured (S46). The back electromotive force Vmg1 is measured by the AC power meter 10. A permanent magnet synchronous motor generates voltage by rotating. By measuring the voltage, that is, the back electromotive force, whether there is abnormality in the state of the motor magnet or the coil or not is tested. Concretely, an effective AC voltage value measured by the AC power meter 10 is recorded together with the rotational angle of the motor by the HV system control unit 4.

After recording the back electromotive force of the motor MG1, the output operation of the engine 5 or motor MG2 is stopped to terminate the operation of testing the motor MG1 (S47). After the operation of testing the motor MG1 is terminated, the output shaft 8 is unlocked (S48a) or the engine shaft locking mechanism 13 is unlocked (S48b). Further, the electric connection between the motor MG1 and the inverter 2 is switched to the ON state by the switch 12. The test of the motor MG1 is terminated, and the program shifts to the test of the motor MG2.

Next, a test of the motor MG2 is conducted. To test the electrical characteristic of the motor MG2, the electric connection between the motor MG2 and the inverter 2 is switched to the OFF state by the switch 12 (S50). In a state where the motor MG2 and the inverter 2 are electrically connected to each other, back electromotive force cannot be measured with high precision due to the influence of the inverter circuit.

The motor MG2 is made run idle and the back electromotive force waveform of the motor MG2 is measured. The idle running methods include a method of locking the motor MG1 and making the motor MG2 run idle by the torque of the engine 5 (a first method) and a method of locking the output shaft of the engine 5 and making the motor MG2 run idle by the torque of the motor MG1 (a second method).

In the case of making the motor MG2 run idle by the first method, the motor MG1 is locked (S51a). Since the motor MG2 is coupled to the engine 5 via the pinion gear 33, if the motor MG1 is not locked, the torque of the engine 5 will not be transmitted to the motor MG2. Consequently, the motor MG1 has to be locked. One of methods of locking the motor MG1 includes an electrical locking method of performing lock control in the motor MG1.

Based on the parameters at the selected failure test point (fP_n), the engine 5 is operated (S52a), thereby allowing the motor MG2 to run idle. In the engine 5, fuel injection control according to the target number of revolutions Ne* is performed. Concretely, arithmetic control is performed by the following arithmetic expression (7);

Te=(Ne*−Ne)×Kp+(Ne*−Ne)×Ki (7)

where Te denotes engine speed control torque, Ne* denotes the target number of revolutions of the engine 5, Ne denotes the actual number of revolutions of the engine 5, Kp denotes proportional control gain, and Ki indicates integral control gain.

In the case of making the motor MG2 run idle by the second method, the output shaft of the engine 5 is locked (S51b). Since the motor MG2 is coupled to the motor MG1 via the pinion gear 33, if the output shaft of the engine 5 (the input shaft of the transaxle 3) is not locked, the torque of the motor MG1 will not be transmitted to the motor MG2. Consequently, the output shaft of the engine 5 has to be mechanically locked. The output shaft of the engine 5 is locked by the engine shaft locking mechanism 13.

Based on the parameters at the selected failure test point (fP_n), the motor MG1 is operated (S52b), allowing the motor MG2 to run idle. In the motor MG1, the number of revolutions is controlled according to the target number of revolutions Nmg1*. Concretely, arithmetic control is performed by the following arithmetic expression (8):

Tmg1=(Nmg1*−Nmg1)×Kp+(Nmg1*−Nmg1)×Ki (8)

where Tmg1 denotes torque for controlling the number of revolutions of the motor MG1, Nmg1* denotes the target number of revolutions of the motor MG1, Nmg1 denotes the actual number of revolutions of the motor MG1, Kp denotes proportional control gain, and Ki indicates integral control gain.

Subsequently, it is determined whether a preset wait time has elapsed since the start of the process in S52a or S52b (S53). When the wait time has elapsed (YES in S53), the program shifts to the process of S54. On the other hand, when the wait time has not elapsed (NO in S53), the process of S53 is repeated.

As the electric characteristic of the motor MG2, back electromotive force Vmg2 of the motor MG2 at the time when the engine 5 or motor MG1 reaches the target number of revolutions is measured (S54). The back electromotive force is measured by the AC power meter 10. Concretely, an effective AC voltage value measured by the AC power meter 10 is recorded together with the rotational angle of the motor by the HV system control unit 4.

After recording the back electromotive force of the motor MG2, the output operation of the engine 5 or motor MG1 is stopped to terminate the operation of testing the motor MG2 (S55). After the operation of testing the motor MG2 is terminated, the output shaft 8 is unlocked (S56a) or the engine shaft locking mechanism 13 is unlocked (S56b). Further, the electric connection between the motor MG2 and the inverter 2 is switched to the ON state by the switch 12 (S57). The test of the motor MG2 is completed, and the program shifts to the abnormality determining test.

It is then determined whether the electric characteristic of the motor is abnormal. First, the back electromotive force Vmg1 of the motor MG1 is checked (S58). Concretely, it is determined whether the measured value Vmg1 lies in the range between an upper limit Vmg1U and a lower limit Vmg1L which are set in advance in accordance with the parameters of the selected test point (fP_n).

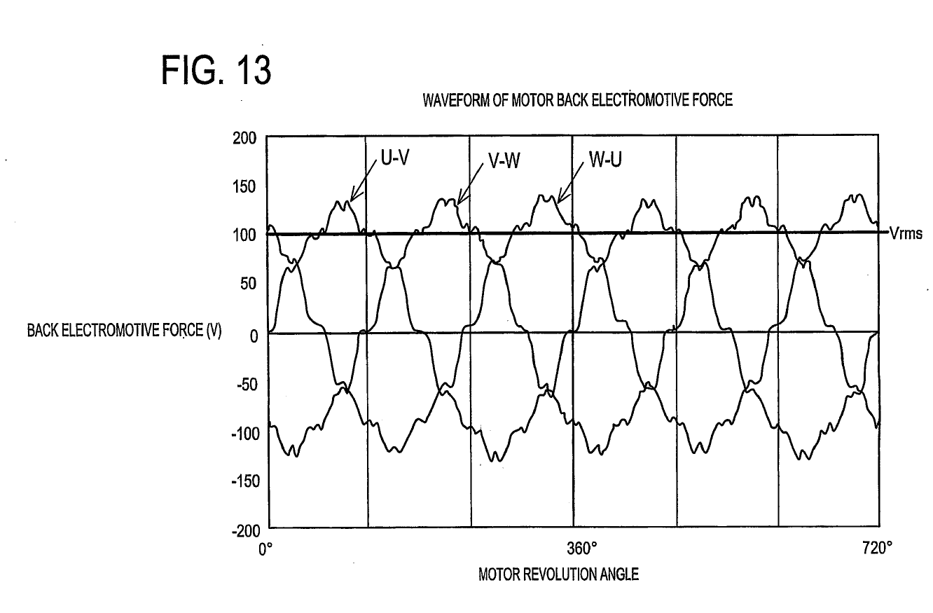

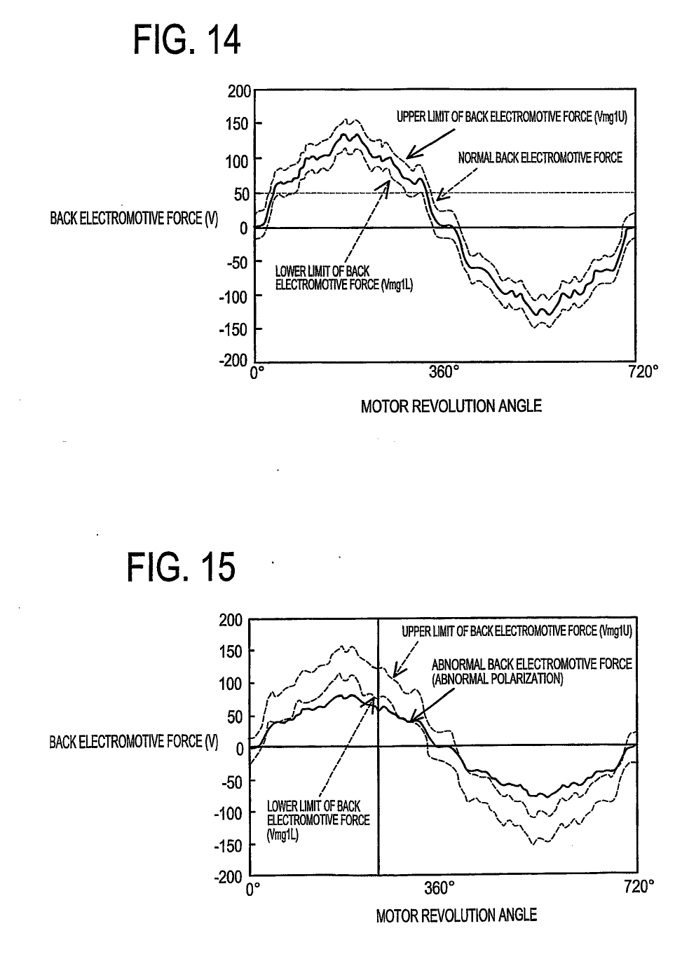

Specifically, for example, when a motor to be tested is a 3-phase AC motor, as shown in FIG. 13, back electromotive forces (U-V waveform, V-W waveform, and W-U waveform) are generated every 120 degrees of the motor rotational angle. The waveforms have basically a sine wave shape. When the back electromotive force waveform is normal, as shown in FIG. 14, the measured waveform lies in the target range. That is, the measured waveform is smaller than the back electromotive force upper limit Vmg1U and larger than the back electromotive force lower limit Vmg1L. However, in some cases, the waveform does not have a perfect sine wave shape but is slightly distorted according to a stator (winding) structure or rotor (magnet) structure.

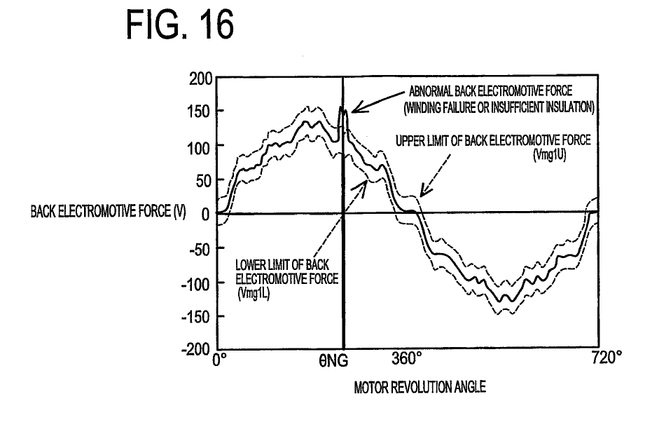

There are, mainly, two patterns of the waveform of an abnormal back electromotive force. In one of the patterns, the waveform is generally out of the target range as shown in FIG. 15. In the case of such a waveform, it can be determined that the back electromotive force is abnormal due to abnormal polarization such as insufficient polarization or excessive polarization. In the second pattern, the waveform is partly out of the target range as shown in FIG. 16. In the case of such a waveform, it can be determined that the back electromotive force is abnormal due to insufficient insulation of the coil or the like. In this pattern, the failure occurrence part of insufficient insulation of the coil or the like can be also specified by the motor rotation angle when the failure is detected. That is, by testing the waveform, the cause of the electric failure of the motor can be specified more particularly.

When the back electromotive force Vmg1 of the motor MG1 lies in the normal range (YES in S58), the back electromotive force Vmg2 of the motor MG2 is checked (S59). Concretely, it is determined whether the measurement value Vmg2 lies in the range between an upper limit Vmg2U and a lower limit Vmg2L which are set in advance in accordance with the parameters of the selected failure test point (fp_n).

When the back electromotive force Vmg2 of the motor MG2 lies in the normal range (YES in S59), it is determined that both of the motors MG1 and MG2 in the transaxle 3 are normal (S59). When the back electromotive force Vmg1 of the motor MG1 is out of the normal range (NO in S58), it is determined that the electric characteristic of the motor MG1 is abnormal. When the back electromotive force Vmg2 of the motor MG2 lies out of the normal range (NO in S59), it is determined that the electric characteristic of the motor MG2 is abnormal.

The mechanical cause test (FIGS. 17 and 18) will now be described. In the mechanical cause test, a test of the motor MG1 (S72 to S81), a test of the motor MG2 (S82 to S86), and determination of a defective motor (S87 and S88) are performed in order. Any of the test of the motor MG1 and the test of the motor MG2 may be performed first. A motor determined as a nondefective product does not have to be tested.

Further, in the test of the motor MG1, a mechanical drag test on a system of the motor MG1, the motor MG2, and the output shaft 8 (S72 to S76), and a mechanical drag test on a system of the motor MG1 and the engine 5 are performed in order. Any of the test on the system of the motor MG1, the motor MG2, and the output shaft 8 and the test on the system of the motor MG1 and the engine 5 may be performed first.

First, one failure test point (fP_n) is selected from preset failure test points (S71). The failure test point selecting order is preset, and the test points are automatically selected in the preset order. The setting of the selecting order is arbitrary. Alternatively, the selecting order can be arbitrarily set by a tester for each test.

Next, when the mechanical drag test is to be performed for the system formed by the motor MG1, the motor MG2, and the output shaft 8, the output shaft of the engine 5 is locked (S72). The motor MG1 is coupled to the engine 5 via the pinion gear 33. Consequently, when the output shaft of the engine 5 (the input axis of the transaxle 3) is locked by the engine shaft locking mechanism 13 and then the motor MG1 is rotated, a mechanical drag torque of the system formed by the motor MG1, the motor MG2, and the output shaft 8 can be measured.

Based on the parameters at the selected failure test point (fP_n), the motor MG1 is operated (S73), thereby allowing the motor MG2 to run idle. In the motor MG1, the number of revolutions is controlled so as to become the target number of revolutions Nmg1*. Concretely, arithmetic control is performed by the following arithmetic expression (9):

Tmg1=(Nmg1*−Nmg1)×Kp+(Nmg1*−Nmg1)×Ki (9)

where Tmg1 denotes torque for controlling the number of revolutions of the motor MG1, Nmg1* denotes the target number of revolutions of the motor MG1, Nmg1 denotes the actual number of revolutions of the motor MG1, Kp denotes proportional control gain, and Ki indicates integral control gain.

In S74, successively, it is determined whether a preset wait time has elapsed since the start of the process in S73. When the wait time has elapsed (YES in S74), the program shifts to the process of S75. On the other hand, when the wait time has not elapsed (NO in S74), the process of S74 is repeated.

As the mechanical characteristic of the part of the transaxle 3 located on the output side of the motor MG1 in the torque transmitting direction, the number-of-revolutions control torque Tmg1 of the motor MG1 at the time when the motor MG1 reaches the target number of revolutions is measured (S75). In a state where the revolution is stable, the number-of-revolutions control torque Tmg1 of the motor MG1 and the mechanical drag torque are equal to each other. Consequently, the number-of-revolutions control torque Tmg1 of the motor MG1 used in the process of S73 is obtained and recorded in the HV system control unit 4.

After recording the number-of-revolutions control torque Tmg1 of the motor MG1, the output operation of the motor MG1 is stopped, thus terminating and the operation of testing the system made by the motor MG1, the motor MG2, and the output shaft 8. After the testing operation is terminated, the output shaft of the engine 5 is unlocked (S76). Then, the program shifts to a test on the system made by the motor MG1 and the engine 5.

At the time of conducting the mechanical drag test on the system made by the motor MG1 and the engine 5, the output shaft 8 of the transaxle 3 is locked (S77). The motor MG1 is coupled to the motor MG2 via the pinion gear 33. Accordingly, by locking the output shaft 8 by the brake 9, the motor MG1 is rotated and mechanical drag torque of the system made by the motor MG1 and the engine 5 can be measured. The lock control may be performed in the motor MG2.

Based on the parameters at the selected failure test point (fP_), the motor MG1 is operated (S78). In the motor control unit 7, the number of revolutions of the motor MG1 is controlled so as to become the selected target number of revolutions Nmg1*. Concretely, the number of revolutions is controlled by the above-described arithmetic expression (9).

In S79, successively, it is determined whether a preset wait time has elapsed since the start of the process in S78. When wait time has elapsed (YES in S79), the program shifts to the process of S80. On the other hand, when the wait time has not elapsed (NO in S79), the process of S79 is repeated.

As the mechanical characteristic of the part of the transaxle 3 located on the input side of the motor MG1 in the torque transmitting direction, the number-of-resolutions control torque Tmg1 of the motor MG1 at the time when the motor MG1 reaches the target number of revolutions is measured (S80). In a state where the revolution is stable, the number-of-revolutions control torque Tmg1 of the motor MG1 and the mechanical drag torque are equal to each other. Consequently, the number-of-revolutions control torque Tmg1 of the motor MG1 used in the process of S78 is obtained and recorded in the HV system control unit 4.

After recording the number-of-revolutions control torque Tmg1 of the motor MG1, the output operation of the motor MG1 is stopped, thus terminating the operation of testing the system formed by the motor MG1 and the engine 5. After the testing operation is terminated, the output shaft 8 of the transaxle 3 is unlocked (S81), and the program shifts to a test of the motor MG2.

At the time of conducting the mechanical drag test of the motor MG2, the rotation of the motor MG1 is locked (S82). The motor MG1 and the engine 5 are coupled to each other via the pinion gear 33. Accordingly, by locking the rotation of the motor MG1, the motor MG2 is rotated and mechanical drag torque of the system formed by the motor MG2 and the engine 5 can be measured. One of methods of locking the rotation of the motor MG1 is a method of performing the lock control on the motor MG1.

Based on the parameters at the selected failure test point (f_n), the motor MG2 is operated (S83). The number of revolutions of the motor MG2 is controlled so as to become the target number of revolutions Nmg2*. Concretely, the arithmetic control is performed by the following arithmetic expression (10):

Tmg2=(Nmg2*−Nmg2)×Kp+(Nmg2*−Nmg2)×Ki (10)

where Tmg2 denotes the-number-of-revolutions control torque of the motor MG2, Nmg2* denotes the target number of revolutions of the motor MG2, Nmg2 denotes the actual number of revolutions of the motor MG2, Kp denotes proportional control gain, and Ki indicates integral control gain.

In S84, it is determined whether a preset wait time has elapsed since the start of the process in S83. When the wait time has elapsed (YES in S84), the program shifts to the process of S85. On the other hand, when the wait time has not elapsed (NO in S84), the process of S84 is repeated.

As the mechanical characteristic of the motor MG2, the number-of-revolutions control torque Tmg2 of the motor MG2 at the time when the motor MG2 reaches the target number of revolutions is measured (S85). In a state where the revolution is stable, the number-of-revolutions control torque Tmg2 of the motor MG2 and the mechanical drag torque are equal to each other. Consequently, the number-of-revolutions control torque Tmg2 of the motor MG2 used in the process of S83 is obtained and recorded in the HV system control unit 4.

After recording the number-of-revolutions control torque Tmg2 of the motor MG2, the output operation of the motor MG2 is stopped, thus terminating the operation of testing the motor MG2. After the testing operation is terminated, the rotation of the motor MG1 is unlocked (S86), and the program shifts to a failure determination test.

Next, whether the mechanical characteristic of the motor is abnormal is determined. First, the drag torque of the motor MG1 is checked (S87). Concretely, it is determined whether the number-of-revolutions control torque Tmg1 lies in the range between an upper limit Tmg1U_loss and a lower limit Tmg1L_loss which are set in advance in accordance with the parameters of the selected failure test point (fP_n).

When the number-of-revolutions control torque (drag torque) Tmg1 of the motor MG1 lies in the normal range (YES in S87), the drag torque of the motor MG2 is checked (S88). Concretely, it is determined whether the number-of-revolutions control torque Tmg2 of the motor MG2 lies in the range between an upper limit Tmg2U_loss and a lower limit Tmg2L_loss which are set in advance in accordance with the parameters of the selected failure test point (fP_n).

When the number-of-revolutions control torque (drag torque) Tmg2 of the motor MG2 lies in the normal range (YES in S88), it is determined that both of the motors MG1 and MG2 are mechanically normal. When the drag torque Tmg1 of the motor MG1 is out of the normal range (NO in S87), it is determined that the mechanical characteristic of the motor MG1 is abnormal. When the drag torque Tmg2 of the motor MG2 lies out of the normal range (NO in S88), it is determined that the mechanical characteristic of the motor MG2 is abnormal.

As described above in detail, in the hybrid vehicle 100 of the embodiment, in a state where a power source (the motor MG1 or MG2 or the engine 5) is mounted on the vehicle, the power source to be tested is operated and the output characteristic of the power source is measured. That is, the output characteristic of the power source in a vehicle as a final product after shipment is measured. Thus, the performance of each of the power sources can be tested in a final product form (a vehicle state) in which the power sources are combined with other hybrid units. The test can be conducted not only during manufacture of a vehicle but also at the end of manufacture (an initial state), during use (aging change) and, further, at the time of occurrence of a failure.

At the measurement of the output characteristic, one of the power sources is locked, that is, only two power sources are allowed to operate. In a state where the operable power sources are operated, the output characteristic of the power source which is operating is obtained. The operation of locking the power sources and acquisition of the output characteristic are executed at least in two combinations while switching the power source to be tested. To be specific, with only one combination, when a failure is determined, the defective one of the two power sources which are operating cannot be specified. By performing the operation in a plurality of combinations, if there is a combination of normal power sources, based on the information, the defective one of the power sources included in the combination determined as abnormal can be specified. Therefore, the hybrid vehicle testing system and method capable of conducting a test for specifying a failure unit in a state where a drive unit for a hybrid vehicle is combined with another unit is realized.

By realizing a test for a power source mounted on a hybrid vehicle in a vehicle state, abnormal operation can be easily reproduced, and an abnormal part can be easily specified. Further, the number of parts to be replaced is minimized.

In the hybrid vehicle 100 of the embodiment, a back electromotive force is obtained by making a motor to be tested run idle. On the basis of the back electromotive force, a failure due to an electric cause in the motor is determined. By locking one of power sources to be tested and operating a motor to be tested, a drag torque is obtained. Based on the drag torque, a failure due to a mechanical cause in the motor is determined. That is, the cause of a failure can be specified more particularly.

The above embodiments are only examples, which do not restrict the present invention, and the present invention may be embodied in other specific forms without departing from the essential characteristics thereof. For instance, the hybrid vehicle as a subject to be tested may be in not only a final product form but also any other form if only the engine 5 and the motors MG1 and MG2 of the transaxle 3 are arranged to transfer power to each other, the operation of each power source can be controlled, and each power source can be locked.

1. A hybrid vehicle testing system for performing a test of a hybrid vehicle in which a drive unit including a first motor and a second motor and an engine are mounted as power sources so that power transmission is allowed between the engine, the first motor, and the second motor,
wherein the testing system is arranged to perform the test by:
locking one of the engine, the first motor, and the second motor;
operating the remaining two power sources to obtain output characteristics of the power sources;
switching locking and operating states of the power sources and obtaining the output characteristics of the power sources to be tested in at least two combinations of the locking and operating states; and
determining whether each power source is normal or not based on the output characteristics.

2. The hybrid vehicle testing system according to claim 1, wherein
the combinations include:
a combination that the second motor is locked, the engine is operated with target torque, and the first motor is operated by number-of-revolutions control to obtain the output characteristic of the first motor, and
a combination that the first motor is locked, the engine is operated with target torque, and the second motor operated by the number-of-revolutions control to obtain the output characteristic of the second motor.

3. The hybrid vehicle testing system according to claim 1 further including a locking mechanism for locking an output shaft of the engine;
wherein the combinations for obtaining the output characteristic of at least one of the motors includes:
a combination that the engine is locked by the locking mechanism, the first motor is operated by torque control, and the second motor is operated by number-of-revolutions control; and
a combination that the engine is locked by the locking mechanism, the second motor is operated by the torque control, and the first motor is operated by number-of-revolutions control.

4. The hybrid vehicle testing system according to claim 1, wherein
the testing system is arranged to perform the test by:
setting one of the first motor and the second motor as a motor to be tested and setting the other as a motor not to be tested;
locking one of the engine and the motor not to be tested and operating the other to obtain back electromotive force of the motor to be tested; and
determining whether the motor to be testes is normal based on the obtained back electromotive force.

5. The hybrid vehicle testing system according to claim 1, wherein
the testing system is arranged to perform the test by:
setting one of the first motor and the second motor as a motor to be tested and setting the other as a motor not to be tested;
locking one of the engine and the motor not to be tested and operating the motor to be tested to obtain drag torque of the motor to be tested; and
determining whether the motor to be tested is normal based on the obtained drag torque.

6. A hybrid vehicle testing method for testing a hybrid vehicle in which a drive unit including a first motor and a second motor, and an engine are mounted as power sources so that power transmission is allowed between the engine, the first motor, and the second motor,
wherein the testing method includes the steps of:
locking one of the engine, the first motor, and the second motor;
operating the remaining two power sources to obtain output characteristics of the power sources;
switching locking and operating states of the power sources and obtaining the output characteristics of the power sources to be tested in at least two combinations of the locking and operating states; and
determining whether each power source is normal or abnormal based on the output characteristics.

7. The hybrid vehicle testing method according to claim 6, including:
A. a step of testing the first motor to obtain the output characteristic of the first motor in a combination that the second motor is locked, the engine is operated with target torque and the first motor is operated by number-of-revolutions control, and
B. a step of testing the first motor to obtain the output characteristic of the second motor in a combination that the first motor is locked, the engine is operated with target torque and the second motor is operated by the number-of-revolutions control.

8. The hybrid vehicle testing method according to claim 6, including:
A. a step of testing the first motor to obtain the output characteristic of at least one of the motors in a combination that the engine is locked, the first motor is operated by torque control and the second motor is operated by number-of-revolutions control, and
B. a step of testing the second motor to obtain the output characteristic of at least one of the motors in a combination that the engine is locked, the second motor is operated by torque control and the first motor is operated by number-of-revolutions control.

9. The hybrid vehicle testing method according to claim 6, wherein
one of the first motor and the second motor is set as a motor to be tested and the other is set as a motor not to be tested,
the testing method further includes the steps of:
obtaining back electromotive force of the motor to be tested in a combination that one of the engine and the motor not to be tested is locked and the other is operated; and
determining whether the motor to be tested is normal based on the obtained back electromotive force.

10. The hybrid vehicle testing method according to claim 6, wherein
one of the first motor and the second motor is set as a motor to be tested and the other is set as a motor not to be tested,
the testing method further includes the steps of:
obtaining drag torque of the motor to be tested in a combination that one of the engine and the motor not to be tested is locked and the motor to be tested is operated; and
determining whether the motor to be tested is normal based on the obtained drag torque.
